(19) United States
(12) Patent Application Publication
(10) Pub. No.: US 2022/0151318 A1
(43) Pub. Date: May 19, 2022

(54) MASK SUPPORT SYSTEM AND METHOD

(71) Applicant: Vanguard Masks, LLC, The Woodlands, TX (US)

(72) Inventors: Nilesh N. Kotecha, The Woodlands, TX (US); Deepak N. Kotecha, Sugarland, TX (US)

(73) Assignee: Vanguard Masks, LLC, The Woodlands, TX (US)

(21) Appl. No.: 17/591,920

(22) Filed: Feb. 3, 2022

Related U.S. Application Data
(63) Continuation-in-part of application No. 17/071,654, filed on Oct. 15, 2020.
(60) Provisional application No. 63/145,787, filed on Feb. 4, 2021.

(51) Int. Cl. A41D 13/11

(52) U.S. Cl. CPC A41D 13/1161; A41D 13/1115

(57) ABSTRACT

An aftermarket device for attachment to a facial mask includes a strip, front fingers and back fingers. The front fingers fold over the strip for retaining an upper edge of a face mask. The strip is configurable to conform to a user's cheeks and around ridge of the user's nose for use. The back fingers are configurable to or otherwise extend along either side of the ridge of the user's nose when in use. The device conforms the facial mask to the user's face in vicinity of the upper edge of the mask, along the cheeks and the user's nose. The device lifts the facial mask from contact with at least a portion of the user's nose and from contact to the mouth.

### CROSS-REFERENCE TO RELATED APPLICATIONS

The present application is related to and incorporates herein by reference and has benefit of priority of U.S. patent application Ser. No. 17/071,654, titled “Mask Support System and Method,” filed Oct. 15, 2020 and Provisional Patent Application No. 63/145,787 titled “Mask Support System and Method,” filed Feb. 4, 2021, which applications are co-pending and have at least one same inventor of the present application.

### TECHNICAL FIELD

The invention generally relates to face masks, and more particularly relates to face mask support structures for comfort and effectiveness.

### BACKGROUND

Face masks are worn for many purposes. Cloth, fiber and similar face masks may be particularly useful to inhibit environmental contaminant inhalation and to limit range of dispersion of exhalation. Presently, people are widely using face masks for social distancing and virus control measure during pandemic. People also wear masks for shielding the nose and mouth from foreign particles, particulates, biologics and other uses. Face masks are widely used in the medical industries, such as by doctors, nurses and other medical staff, to better protect themselves and patients.

There are many different types, configurations, materials, sizes, pliability, flexibility, fit and other variations of face masks. Some common masks are surgical masks of filter material, masks of flexible materials, masks of fabric, and combinations. Certain masks are mass manufactured, whereas others are manufactured by small shops and individuals. Some masks are sewn or otherwise fixed with straps for retaining the mask in place on the user's face. Straps may be elastic, tied or otherwise fixed.

Proper placement and wear of a face mask can be important. For example, it would generally be desired that the mask conform to the face, including around the nose and eyes. Moreover, generally it is recommended that to avoid contamination, hand contact (as well as other contact) of the mask fabric wrap portion should be avoided. Face conformance is often hindered by features of the face, such as the nose region, and improper conformance can limit effectiveness and comfort of the mask in wear. Also, a mask that touches tip of the nose in use or that slides or moves on the user's face can cause irritation of the nostril, cheeks and more, causing a user to rub or otherwise touch the mask fabric wrap portion leading to contamination.

In general, masks, both factory manufactured and those made by hand or personal sewing machine, must be comfortable to the wearer to be effective and useful. Most available masks do not conform to the face in a manner that leads to this. Some conventional masks have included a narrow strip of a metal or plastic near a location for bridge of the nose during use. This narrow strip is typically effective only to cause the mask to conform to the nose bridge at a small strip section and to conform to the cheeks under the eyes. Although such a narrow strip may be helpful to position and conform the mask, conventional masks nevertheless tend to have deficiencies in comfort, conformance, and effectiveness. Nonetheless, a variety of conventional face masks, of varied type, configuration and otherwise, are in widespread use, particularly during pandemic.

It would, therefore, be a significant improvement in the art and technology to provide an adaptable mask support system that may be fitted to virtually any face mask worn over the nose and mouth, including those that are conventional and many new designs that may become available. It would also be a significant improvement in the art and technology to make the adaptable mask support system easily manufactured, of readily available materials. Even more, it would be a significant improvement in the art and technology to provide a combination of features to extend a mask portion along the nose bridge to yield comfort, effectiveness, and other advantages.

### SUMMARY

An embodiment of the invention is a system including a support layer and an adhesive segment on a side of the support layer.

Another embodiment of the invention is an aftermarket device for attachment to a facial mask. The device includes a support layer sized to fold over and under a central portion of an upper edge of the facial mask and extend laterally from centrally along the upper edge, and an adhesive segment connected to the support layer configured to connect to the facial mask.

Yet other embodiments of the invention include methods of manufacture of the device(s).

### BRIEF DESCRIPTION OF THE DRAWINGS

The present invention is illustrated by way of example and not limitation in the accompanying figures, in which like references indicate similar elements, and in which:

FIG. 1 illustrates a top view of a system for support of a face mask, according to certain embodiments of the invention;

FIG. 2 illustrates a bottom view of a system for support of a face mask, according to certain embodiments of the invention;

FIG. 3 illustrates a side cross-section view of a system for support of a face mask, according to certain embodiments of the invention;

FIG. 4 illustrates a side cross-section view of a system for support of a face mask including a laminate, according to certain embodiments of the invention;

FIG. 5 illustrates a side cross-section view of a system for support of a face mask, including a large adhesive, according to certain embodiments of the invention;

FIG. 6 illustrates a side cross-section view of a system for support of a face mask, including a laminate and large adhesive, according to certain embodiments of the invention;

FIG. 7 illustrates a side view of a system according to FIGS. 1, 2 and/or 3 for support of a face mask, including a support layer and adhesive, according to certain embodiments of the invention;

FIG. 8 illustrates a side view of a system according to FIGS. 1, 2 and/or 4 for support of a face mask, including a laminate as support layer and adhesive, according to certain embodiments of the invention;

FIG. 9 illustrates a front perspective view of a support connected to a semiconical or elliptical mask, according to certain embodiments of the invention;

FIG. 10 illustrates a front perspective view of a support connected to a generally square or rectangular mask, according to certain embodiments of the invention;

FIG. 11 illustrates a front and left side perspective view of a support connected to a mask in wear, according to certain embodiments of the invention;

FIG. 12 illustrates a left side perspective view of a support connected to a mask in wear, according to certain embodiments of the invention;

FIG. 13 illustrates a top view of another system for support of a face mask, including a strip with front and back fingers, according to certain embodiments of the invention;

FIG. 14 illustrates a front perspective view of the system of FIG. 13, including front fingers, according to certain embodiments of the invention;

FIG. 15 illustrates a back perspective view of the system of FIGS. 13 and 14, including back fingers, according to certain embodiments of the invention;

FIG. 16 illustrates a front view of the system of FIGS. 13-15, attached to an example face mask, according to certain embodiments of the invention;

FIG. 17 illustrates a back view of the system of FIGS. 13-16, attached to the example face mask, according to certain embodiments of the invention; and

FIG. 18 illustrates a top and front perspective view of the system of FIGS. 13-15, in use (without face mask) for configuration to a face of a user, according to certain embodiments of the invention.

### DETAILED DESCRIPTION

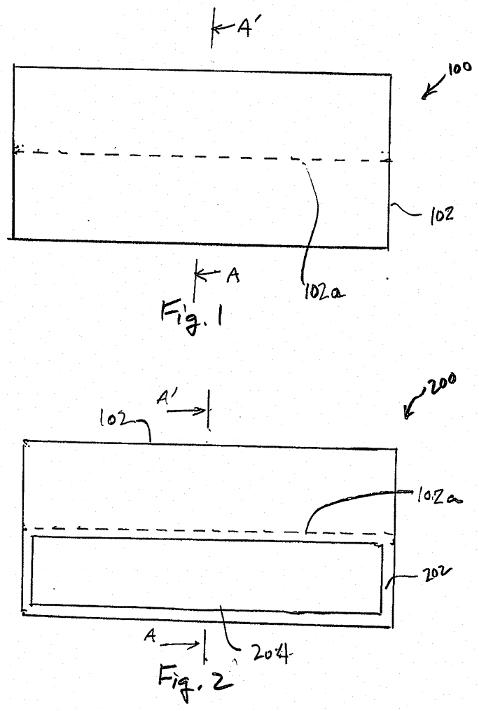

Referring to FIGS. 1 and 2, in conjunction, a mask support 100, 200 includes a foldable bridge 102 connected to an adhesive segment 202. The foldable bridge 102 has a length and a width. The length of the foldable bridge 102 may be, for nonexclusive example, on the order of three to six inches or otherwise as desired. Desired length of the foldable bridge 102 may extend sufficient to span from cheek to cheek of a face over and across bridge of the nose. The width of the foldable bridge 102 may be, for nonexclusive example, on the order of one to two and a half inches or as otherwise desired. Along about mid-width of the foldable bridge 102, the foldable bridge 102 may be folded lengthwise to include a fold 102a, according to certain nonexclusive embodiments.

The foldable bridge 102 may be formed of a variety of materials. As nonexclusive example, the foldable bridge 102 may be a single layer or a laminate or composite, or combinations. The foldable bridge 102 is generally bendable and or pliant as a fabric. In certain non-exclusive embodiments, the foldable bridge 102 is a foam, cushion or soft material suitable for prolonged or otherwise desired contact with facial skin. The foldable bridge 102 may, but need not in all embodiments, be or include a layer that conforms to a bridge of a nose and adjacent cheeks under eyes of a face. For nonexclusive example, the foldable bridge 102 is or includes a metal, plastic or other rigid, flexible, formable, or other material.

Continuing to refer to FIG. 2, an opposing side of the foldable bridge 102 to that of FIG. 1, includes the adhesive segment 202 connected along a side 202 of the fold 102a. The adhesive segment 202 may be a tape or other connector that is either fixedly or removably attachable to a mask material. A nonexclusive example of the adhesive segment 202 is a strip of a double-sided tape. The exposed side of the adhesive segment 202 in FIG. 2 may be packaged or prepared for subsequent use with a foil or other covering that is removable when the adhesive segment 202 is used for attachment to a mask material.

In operation, the foldable bridge 102 is positioned lengthwise to align along a top edge of a face mask of the type that covers nose and mouth of the wearer, centered along the edge of the mask on the nose bridge apex of the mask or otherwise fairly centralized along a top edge. The foldable bridge 102 is folded along the fold 102a with the fold 102a aligned along the edge of the mask and the folded wings bent towards inner and outer surfaces of the mask material. The adhesive segment 202 is attached to the outer surface of the mask along the edge.

In use, the face mask with foldable bridge 102 attached is placed in position on the face over the nose and mouth. The foldable bridge 102 is located over the bridge of the nose of the wearer. The foldable bridge 102 is sufficiently rigid to outwardly extend the mask beyond tip of the nose. Moreover, the conformability of the foldable bridge 102 to the nose and adjacent cheeks rests the mask in position on bridge of the nose and against the wearer's face. As so positioned on the face, the mask may be attached by applicable features, such as straps, strings or cords of the mask for such purpose.

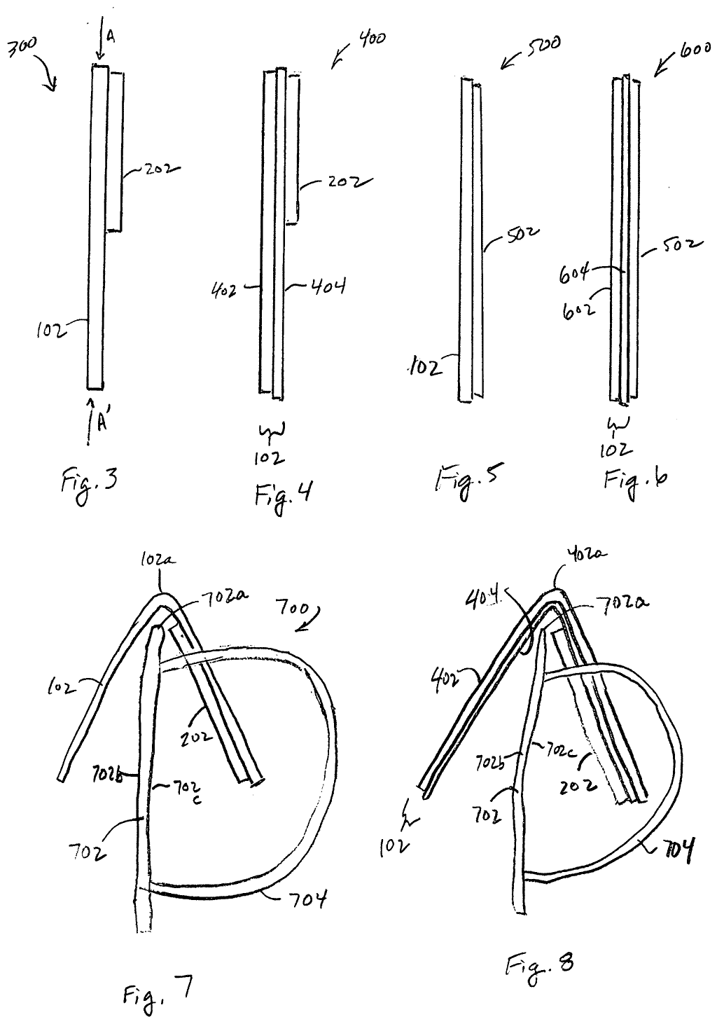

Referring to FIG. 3, a system 300 for support according to nonexclusive embodiments, in cross-section, includes a foldable bridge 102 connected to an adhesive segment 202. The adhesive segment 202 covers some or all, as applicable in nonexclusive embodiments, of a wing of the foldable bridge 102. The foldable bridge 102 is a flexible material, such as a cloth, mesh, metal, plastic or other, or combinations. The adhesive segment 202 is sufficient to attach the system 300 to a face mask, at the edge and extending over a portion of front face.

Referring to FIG. 4, a system 400 for support according to other nonexclusive embodiments, in cross-section, includes a foldable bridge 102 constructed of a laminate of an outer layer 402, such as for nonexclusive example a cloth, fabric, weave, filter, or other flexible material, and a rigidity enhancing layer 404, such as a metal, plastic, composite, or other material for conforming and retaining shape to a nose bridge and cheeks of a mask. The rigidity enhancing layer 404 need not be highly rigid but should be sufficient to, when installed on a face mask, extend the nose contacting section of the mask along the nose bridge line and outward from the nose tip. The foldable bridge 102 in embodiments conforms an upper edge of a face mask substantially consistent with a contour of the nose and cheeks in manner extending mask filter surface along bridge of the nose and, in general, slightly beyond nose tip. Although the laminate is illustrated as two layers, the laminate may be configured from any number of layers more than one.

Referring to FIG. 5, a system 500 for support according to certain nonexclusive embodiments, in cross-section, includes a foldable bridge 102 constructed of a single layer connected to an alternative adhesive segment 502. In the embodiment, the adhesive segment 502 extends across greater portion of the foldable bridge 102, for nonexclusive example, substantially to the edge of the foldable bridge 102. In such embodiment, the foldable bridge 102 when folded engages both planar sides of a face mask along an edge near top (in use) such that the foldable bridge 102 conforms generally to the nose bridge and slightly beyond and the cheeks.

Referring to FIG. 6, a system 600 for support according to certain nonexclusive embodiments, in cross-section, includes a foldable bridge 102 formed of a laminate of an outer layer 602 and a rigidity enhancing layer 604. Although the laminate is illustrated as two layers, embodiments include any number of layers with at least one of the layers servicing as a rigidity enhancing element and at least one of the layers servicing as a filter or masking element. The rigidity enhancing element is conformable, such as be bend or press, to a nose and cheek portions of a mask wearer's face.

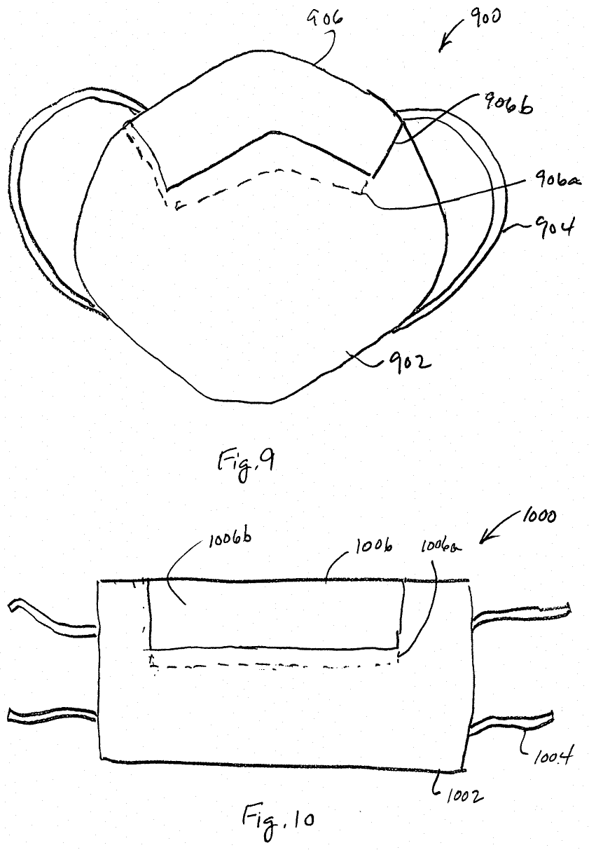

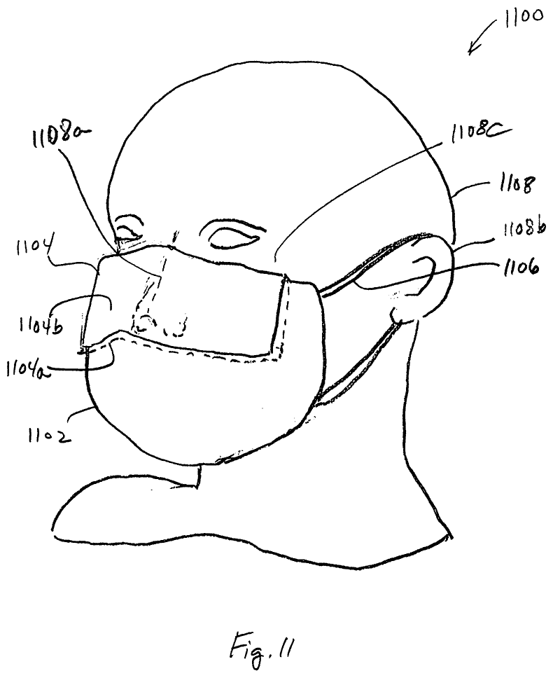

Referring to FIG. 7, a system 700, such as the system 100 and 300 of FIGS. 1 and 3, respectively, is attached to an edge 702a of a mask 702 in the nose and check region in wear. In attachment, the bend 102a of the foldable bridge 102 is position along the edge 702a, centered in vicinity of the nose and cheek area of the mask 702. Respective sides of the foldable bridge 102 are draped over the inner 702c and outer surfaces 704b of the mask 702. The adhesive segment 202 is pressed against the inner 702c surface of the mask 702. The excess of the foldable bridge 102 on other side of the fold 102a is folded against the outer 702b surface of the mask 702. The mask 702 may include straps 704 connected at sides of the mask for retaining the mask 702 with system 700 to the wearer. The straps 704 can alternatively in embodiments be or include any other retention element or elements, alone or in combination.

Referring to FIG. 8, a system 800, such as the system 400 of FIG. 4, is attached to an edge 702a of the mask 702. Attachment is centered along a top of the mask 702 for the nose and cheeks location in wear. The foldable bridge 402 in the embodiment includes a laminate of the outer layer 402 and a rigidity enhancing layer 404. The rigidity enhancing layer 404 is, according to certain nonexclusive embodiments, moldable or conformable to a nose bridge and cheeks surface of a wearer's face. The rigidity enhancing layer 404 may be formed to substantially maintain the molded or conformed shape configured by the wearer, or otherwise be reusable to subsequently differently or additionally mold or conform or otherwise shape. Alternately, the shape may be preset or induced, or other alternates. The adhesive segment 202 is pressed against the inner side 702c of the mask 702, and the foldable bridge 402 on the other side of the fold 402a is folded against he outer 702b side of the mask 702. Straps 704 and/or other connective elements may be included in the mask 702.

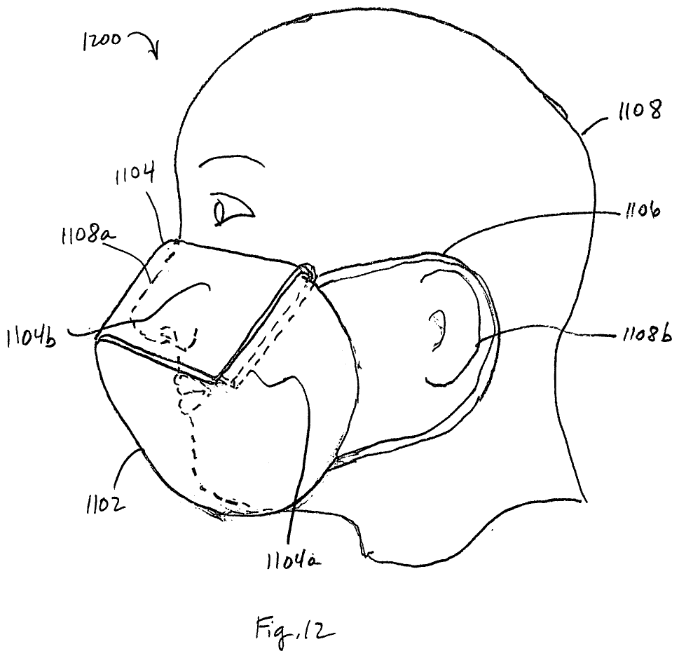

Referring to FIG. 9, a semiconical or somewhat elliptical shaped mask 902 of the type which includes a relatively fixed or sturdy accommodating design or structure, such as for nonexclusive example a conventional fiber or woven surgical mask, includes an attached foldable bridge 906. The foldable bridge 906 may, but need not necessarily, be an after-market product for addition to an existing type of the mask 902 or otherwise. The foldable bridge 906 is of any type previously discussed or otherwise. The foldable bridge 906 is folded over an upper edge of the mask 902, centered around the nose bridge and cheek areas of contact during wear. An inner (shown in phantom) wing 906a of the foldable bridge 906 includes an adhesive to fix the wing 906a to an inside surface of the mask 902. The foldable bridge 906 opposing a bend along the mask edge forms an outer wing 906b that is folded against an outer surface of the mask 902. In use, the foldable bridge 906 forms a more rigid and conformed contact with the bridge of the nose and cheeks beneath the eyes of a wearer. The foldable bridge 906 may be conformable by the wearer. The foldable bridge 906 may extend in the inner wing 906a to beyond the tip of the nose of the wearer. The foldable bridge 906 therefore can, in various embodiments, avoid irritating touch of the mask 902 directly to the nose (other than the bridge) and also conform to the nose bridge and cheeks, all for better comfort and better sealing protection of the wearer.

Referring to FIG. 10, a flat extended shaped mask 1002 of the type which includes a somewhat square or rectangular and flexible shape, such as for nonexclusive example a sewn cloth or fiber mask, includes an attached foldable bridge 1006. The foldable bridge 1006 may, but need not necessarily, be an after-market product for addition to an existing type of the mask 1002 or otherwise. In certain nonexclusive embodiments, a foldable bridge is sold or made available as an add on to virtually any type, composition, shape and other variation of a mask. Moreover, the foldable bridge can be one time use or multi time use, on same or different masks, or otherwise as desired. In embodiments, the foldable bridge 1006 is folded over an upper edge of the mask 1002, centered around the nose bridge and cheek areas of contact during wear. An inner (shown in phantom) wing 1006a of the foldable bridge 1006 includes an adhesive to fix the wing 1006a, either permanently, removably or otherwise, to an inside surface of the mask 1002. The foldable bridge 1006 opposing a bend along the mask edge forms an outer wing 1006b that is folded against an outer surface of the mask 1002. In use, the foldable bridge 1006 forms a somewhat more rigid and conformed contact with the bridge of the nose and cheeks beneath the eyes of a wearer. According to embodiments, the foldable bridge 1006 may be conformable by the wearer, may have a form or configuration, may be variable in configuration, and otherwise. The foldable bridge 1006 may extend in the inner wing 906a to beyond the tip of the nose of the wearer. In various embodiments, the foldable bridge may avoid irritating touch of the mask 1002 directly to the nose and also conform to the nose bridge and cheeks of the wearer for better fit. The foldable bridge may allow for greater comfort and better sealing protection in use with the mask worn by the wearer.

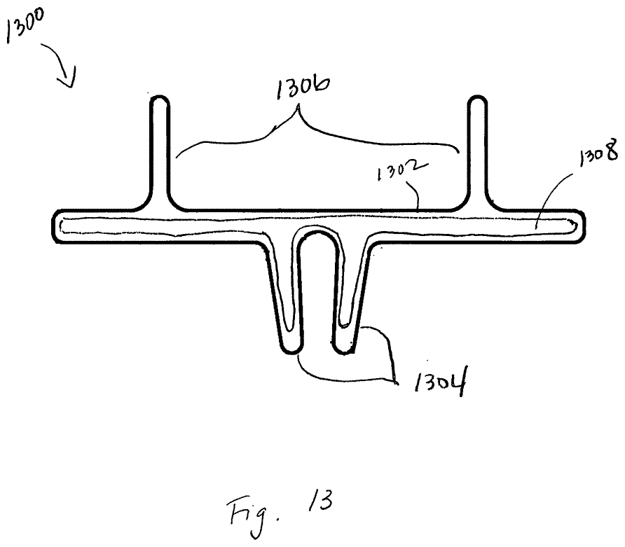

Referring to FIG. 11, a system 1100 includes a face mask 1102 with connected straps 1106. Connected to the mask 1102 is a support 1104. The support 1104 is configured to conform to facial features of a nose bridge 1108a (shown in phantom) and cheeks 1108c of a wearer 1108 of the mask 1102. The mask 1102 is retained in wear by the wearer by the straps 1106. As worn, the mask 1102 covers the nose and chin regions of the wearer 1108. A nose bridge support 1104 is attached to the mask 1102 centered on the nose location. The support 1104 connects to the mask 1102 at an upper edge of the mask 1102, and is folded over the edge in engagement. The support 1104 includes an adhesive segment (not shown in detail) that fixedly, removably or otherwise connects the support 1104 to the mask 1102. The support 1104, when the mask 1102 with support 1104 is worn, lies along bridge 1108a of the nose and may conform at least at and/or near an upper edge to the nose and cheeks 1108c of the wearer 1108. Straps 1106 of the mask 1102 or similar retainers maintain the mask 1102 to the wearer 1108.

The support 1104 may be formed of materials that provide a measure of rigidity to support the mask 1102 when connected to it. The support 1104 may be configurable for conformance to facial features of the wearer 1108, such as, for non-exclusive example, the support may be formed of or include a hand or other deformable material that substantially retains a shape. Examples of materials of the support 1104, in addition or not of any covering, fabric, weave, filter, or other materials, whether as laminate or otherwise, may include, but are not limited to metal, aluminum, tin, plastic, rubber, and other deformable or configurable materials. Embodiments include such materials that will extend the mask in supporting fashion from top of the mask to tip of the nose bridge and/or otherwise. Embodiments also include such materials that will conform to facial features of the nose and cheeks to limit separation of the mask from touching the face.

Referring to FIG. 12, in conjunction with FIG. 11, a system 1200 includes the support 1104 connected to the mask 1102. The mask 1102 with support 1104 are in place in wear by the wearer 1108. The support 1104 includes a fold along upper edge of the mask 1102. The support 1104 is centered in about the location of the nose in the upper portion of the mask 1102. The support 1104 includes a first wing 1104a on a side of the fold and connected to an underside of the mask 1102. A second wing 1104b of the support 1104 extends against an upper side of the mask. In certain nonexclusive embodiments, the support 1104 extends the mask 1102 from direct contact with face of the wearer 1108 below the nose tip and to under the mouth. It is believed that extension allows for greater comfort of wear of the mask with support, conforms the mask to the face at an upper edge, allows more ease of mouth movement during vocalizations, and assists to avoid frequent touch of outer surfaces of the mask as may be otherwise desirable to the wearer in adjusting and wear of the mask.

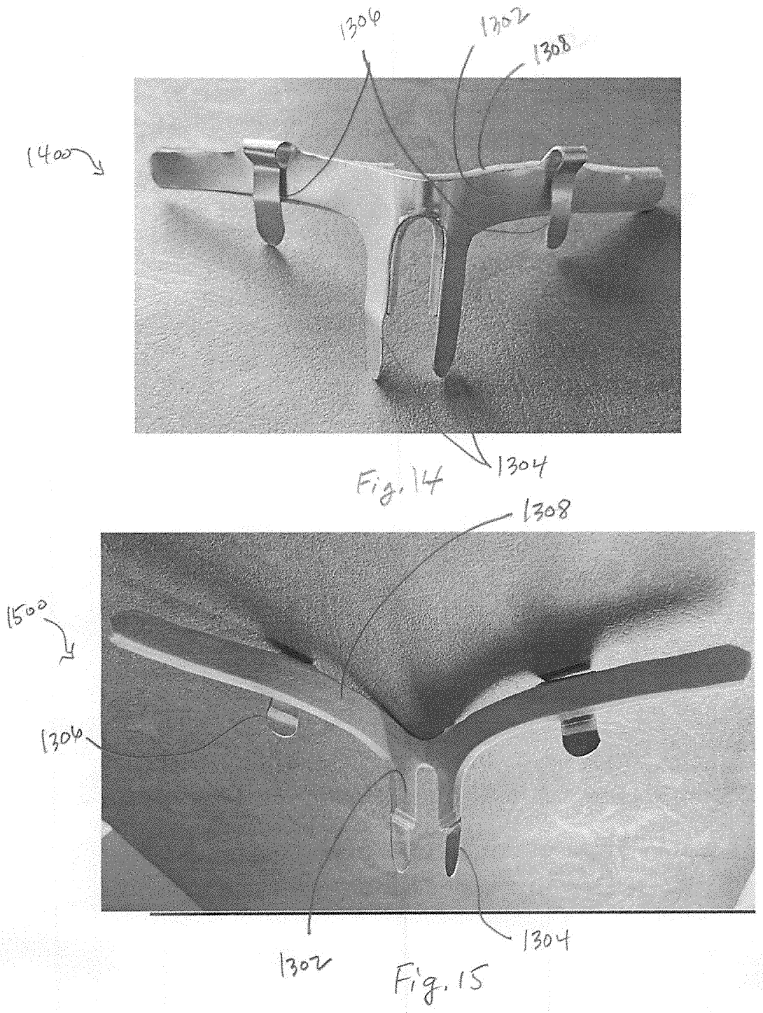

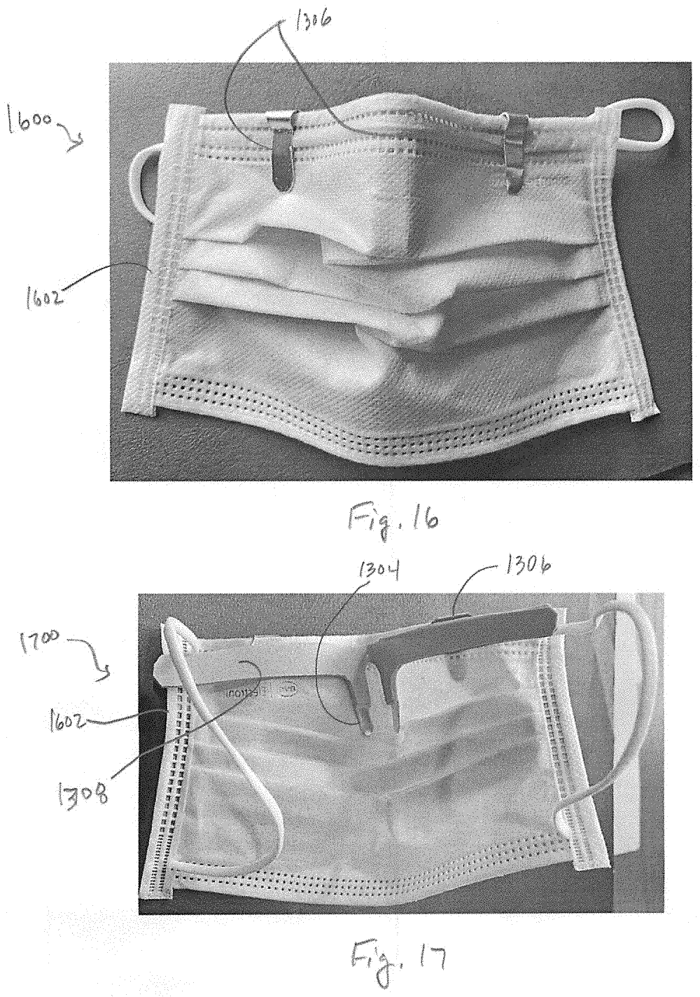

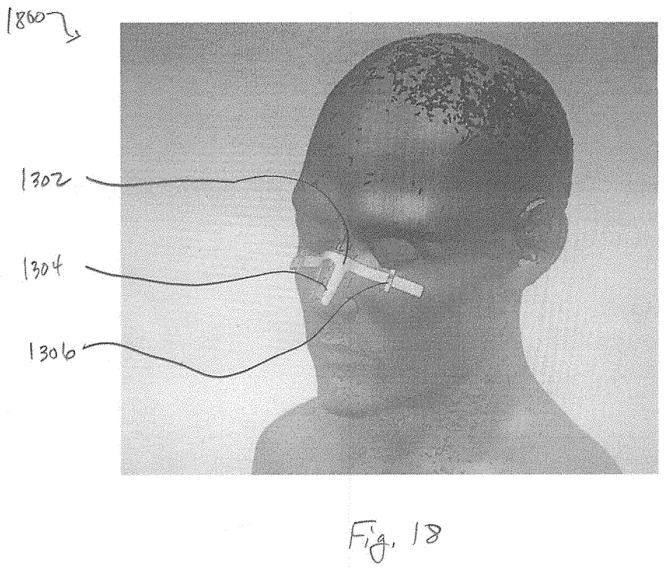

Referring to FIGS. 13-18, another mask support system 1300, 1400, 1500, 1600, 1700, 1800 includes a strip 1302 connected to front fingers 1306 and back fingers 1304. The back fingers 1304 are respectively centered near the center of the strip 1302. The back fingers 1304 are sized and positioned on the strip 1302 sufficient to extend along either side of the fulcrum of a user's nose, as hereafter described. The front fingers 1306 are centered on the strip 1302 nearer to ends of the strip 1302. The front fingers 1306 are sized, positioned and (as will be apparent) configured to retain the support system 1300 to a face mask of a user.

A padding 1308 is connected extending along at least a portion of a back of the strip 1302 and extending along at least a portion of the back of the back fingers 1304. The padding 1308 cushions the frame of the strip 1302 and back fingers 1304 against a user's face when the system 1300, 1400, 1500, 1600, 1700, 1800 is employed with a face mask 1602.

The system 1300, 1400, 1500, 1600, 1700, 1800 is configured such that it is conformable to a user's face and to retain a face mask 1602. The front fingers 1306 may be formed as grips to retain an upper edge of a face mask 1602. The strip 1302 is configurable to follow surface of a user's face from cheek around nose, and to opposite cheek. The back fingers 1304 are positioned to extend downward from the strip 1302 along sides of the ridge of a user's nose and to lift the mask 1602 from direct contact with the ridge and certain portions of the nose.

The mask 1602 can be any cloth, filter paper, composite, or other material. A conventional N95 or other mask, as example, can be connected to the strip 1302 by the front fingers 1306 folded over the edge of the mask 1602. The strip 1302 then extends along the edge of the mask 1602 on a back side. The strip 1302 is conformed to the ridge of a user's nose and extending along respective cheeks of the user. The padding 1308 may contact the user's face skin to reduce friction and direct contact of the strip 1302 to the nose and cheeks. The back fingers 1304 and padding 1308 thereon may extend along either side of the ridge of the user's nose.

A wide variety of materials are possible in the system 1300, 1400, 1500, 1600, 1700, 1800. In certain embodiments, the strip 1302 and front fingers 1306 and back fingers 1304 are aluminum, metal, plastic, rubber or other material or combinations configurable in shape of the nose and cheeks to conform the mask 1602 to the face. The back fingers 1304 are configurable to extend along either side of the ridge of the nose of the user. The front fingers 1306 are configured to retain a mask top edge. The padding 1308 can be any rubber, polymer, cotton, or other material or combinations that conforms to the shape of the strip 1302 and back fingers 1304, and that limits agitation, rub or reaction with the hsking of the face.

The foregoing supports for a mask are manufacturable of a wide variety of materials. For nonexclusive example, the supports may be or include any of a wide range of deformable or conformable materials that will maintain conformance of the mask to the wearer's facial features. Certain materials may include, without limitation, metal, plastic, aluminum, tin, composite, fiber, rubber, and others, including combinations of materials whether any of these or any others. Moreover, the supports may include whole or partial laminates. A wide variety of glues, adherents, gums, and other adhesive or joining materials may be included as the adhesive segment or similar retaining mechanism for securement to the facial mask. In manufacture, the supports may be molded, formed by hand, glued, stamped, cut, layered, segregated, sewn, and otherwise manipulated and configured. All other possibilities, now or hereafter known or available, are included.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention.

Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is Claimed is:

1. An aftermarket device for attachment to a facial mask, comprising:
a strip sized to extend from cheek to cheek, along the nose, of a user of the device;
a finger for fold over the strip to retain at least a portion of an upper edge of a facial mask; and
another finger extending from the strip to extend along ridge of the user's nose to lift the mask from direct contact with the nose and mouth of the user.
